(19) United States
(12) Patent Application Publication
(10) Pub. No.: US 2001/0032097 A1
(43) Pub. Date: Oct. 18, 2001

(54) Method and system for collecting and presenting information relating to compensations

(76) Inventor: Jonah S. Levey, New York, NY (US)

Correspondence Address: PENNIE AND EDMONDS, 1155 AVENUE OF THE AMERICAS, NEW YORK, NY, 100362711

(21) Appl. No.: 09/841,964

(22) Filed: Apr. 25, 2001

Related U.S. Application Data
(60) Provisional application No. 60/200,336, filed on Apr. 28, 2000.

(51) Int. Cl. G06F 17/60

(52) U.S. Cl. 705/1

(57) ABSTRACT

A method of providing compensation comparison data is described. The method includes the steps of receiving compensation data from a plurality of sources, determining whether the received data is reliable, and marking each piece of received data as reliable or unreliable. The method further includes the steps of authenticating each piece of received data marked as unreliable and calculating an average of the authenticated data. A corresponding system is also described.

### CROSS-REFERENCE TO RELATED APPLICATIONS

This application claims the benefit of U.S. Provisional Application No. 60/200,336, filed Apr. 28, 2000.

### BACKGROUND OF THE INVENTION

In the current job market, the high mobility of workers is taken for granted. In such a fast-changing job market, workers and their employers would stand to benefit from receiving up-to-date and reliable compensation data (e.g., salaries and bonuses) to remain competitive.

Typically, government agencies and trade organizations provide compensation information for one or more specific industries by publishing them in books and magazines. Moreover, a number of Web sites have begun to provide compensation data over the Internet as well. Regardless of how the compensation data are delivered to consumers of such data, compensation surveys are required to be collected and analyzed before they are published.

In collecting compensation data using surveys, survey forms are mailed to potential respondents. Socially conscientious ones among the potential respondents would accurately fill out the forms and mail them back. Once the forms are received, the information contained in the received forms is analyzed. This process presents at least two weak links that may cause the resulting compensation data to be inaccurate. First, since there is no incentive for the potential respondents to fill out the survey forms, the respondents who fill out the forms may not accurately reflect the compensation data of all of the potential respondents. Further, when the survey forms are inaccurately filled out, either by mistake or deliberately, there is no mechanism to eliminate them from the analysis.

The above-described process also presents a timeliness problem because the survey process (i.e., mailing out survey forms to potential respondents, receiving survey forms back from them, analyzing the collected survey information and publication of the analysis) may take weeks or months. Thus, the collected survey information may become obsolete by the time it is published. Moreover, because of the expenses and logistics involved in mailing, receiving, and analyzing the compensation survey forms, the surveys typically take place in long intervals (e.g., one or two years).

Many of these shortcomings are not eliminated by Web sites that may provide compensation information to their users, since the typical Web sites present their compensation information based on the above-discussed government or trade group-sponsored compensation surveys.

### SUMMARY OF THE INVENTION

The present invention provides a method for collecting and presenting reliable and up-to-date compensation data. In particular, the method of the present invention includes the steps of receiving compensation data from a plurality of sources, determining whether the received data is reliable, and marking each piece of received data as reliable or unreliable. The method further includes the steps of authenticating each piece of received data marked as unreliable and calculating an average of the authenticated data. A corresponding system is also described.

### BRIEF DESCRIPTION OF THE DRAWINGS

Preferred features of the present invention are disclosed in the accompanying drawings, wherein identical reference characters denote like elements throughout the several views, and wherein:

FIG. 1 is an overall block/system diagram of the present invention;

FIG. 2 is a block/system diagram of a Web server of the present invention;

FIG. 3 is a flow chart illustrating steps performed by a processor of the present invention; and

FIGS. 4-6 are graphs illustrating various ways to present compensation data.

### DETAILED DESCRIPTION OF THE INVENTION

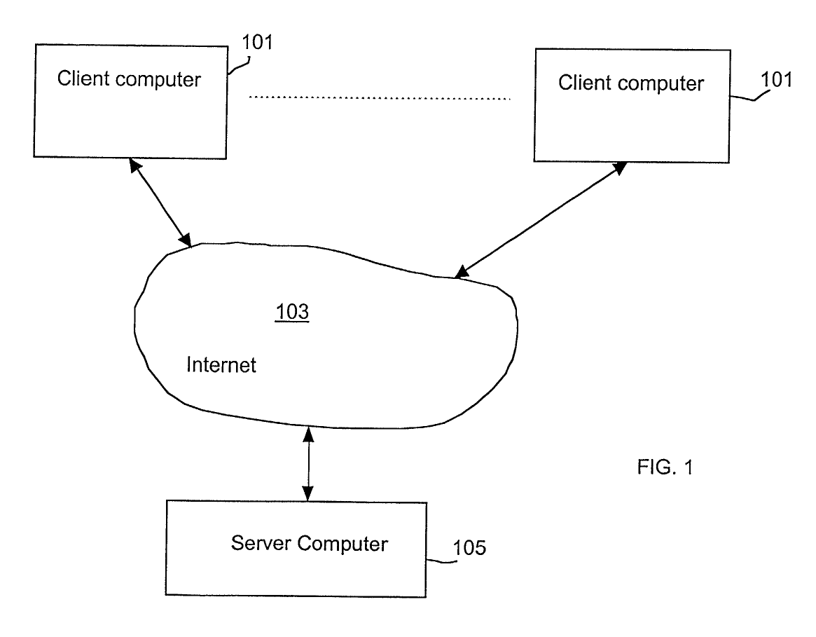

Referring to FIG. 1, the present invention preferably includes a number of client computers 101 connected to a server computer 105 via the Internet 103. Various other ways to connect client computers 101 to server computer 105 available to one skilled in the art are also contemplated within the present invention.

The following discussion of client computer 101 is mostly directed to one client computer 101 and one user thereof. It should be noted that the same descriptions of the client computer and its features are to be duplicated in other client computers 101 and for numerous users thereof.

Client computer 101 is preferably a personal computer (PC). The specific type of processor and operating system used by client computer 101 is not critical to the present invention. As noted above, client computer 101 is preferably linked to server computer 105 via the Internet 103. Client computer 101 and server computer 105 preferably communicate with each other using a common communication protocol, such as Hypertext Markup Language (HTML), Java, JavaScript, Extended Markup Language (XML), or other similar communication protocol available in the art.

In the operation of the present invention, a member user (the “member”) located at client computer 101 browses a Web site provided by server computer 105. After an initial login process and/or registration process as known in the art, the member may download one or more survey Web pages containing compensation survey questionnaires. In particular, the survey Web pages may include data entry fields to enter current base salary, estimated cash bonus, and/or other incentive compensations (e.g., profit sharing, stock options, car allowance, and other similar non-salary forms of compensation) of the member. The survey Web pages may also include data entry fields to enter compensations of previous years to provide historical information. Moreover, the survey Web pages further include data entry fields to enter employer name, office location, and job title/description. It should be noted that the member may enter one or more of the above discussed data entry fields. The member-entered data are converted to a format that can be transmitted over the Internet 103.

In addition, without providing compensation data as discussed above, the member may request compensation data from server computer 105. This is possible because the market compensation data collected from other members are analyzed and arranged for presentation by server computer 105. The analysis and presentation steps performed by server computer 105 are described in detail below. Hence, server computer 105 may download one or more Web pages containing the requested compensation data to client computer 101.

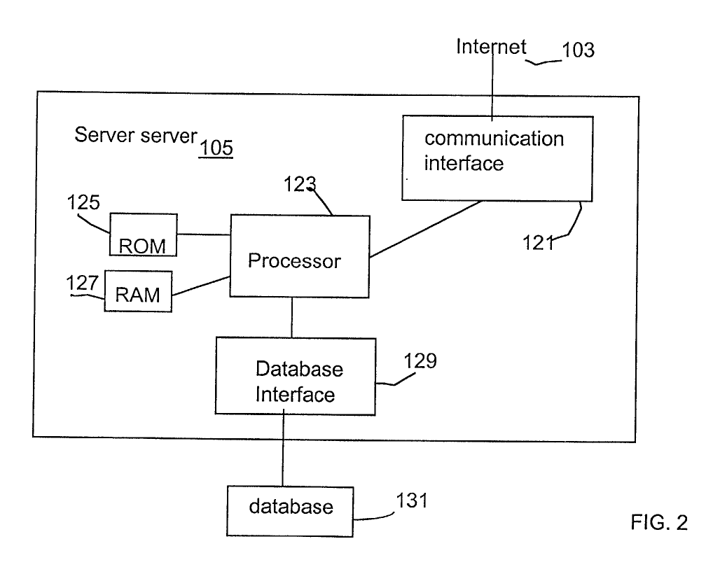

Turning to FIG. 2, server computer 105 includes a communication interface 121, one or more processors 123, random access memory (RAM) 125, read-only memory (ROM) 127, a database interface 129, and other conventional components of an Internet Web server as known in the art.

Communication interface 121 is preferably configured to transmit and receive electronic messages from remote locations (i.e., client computers 101) via the Internet 103 using a common communication protocol such as TCP/IP and/or a common Web browser (e.g., Netscape). In particular, communication interface 121 receives the above-discussed compensation survey data/information collected by client computers 101 and transmits the above-discussed market compensation data to client computers 101.

ROM 125 and other storage devices preferably store a number of software applications which are to be downloaded to processor 123 and executed therein. The software applications include operating systems, device drivers, and other software applications as known in the art. Moreover, the software applications further include computer executable instructions necessary to run various programs, Web page generation and storage, and other software applications necessary to provide numerous features of the present invention as discussed herein.

Via database interface 129, server computer 105 is coupled to a database 131. Database 131 is preferably implemented using conventional database management system such as Encore® or other similar products. Database interface 129 is configured to generate appropriate search commands to retrieve and store relevant data from database 131 based on commands from processor 123.

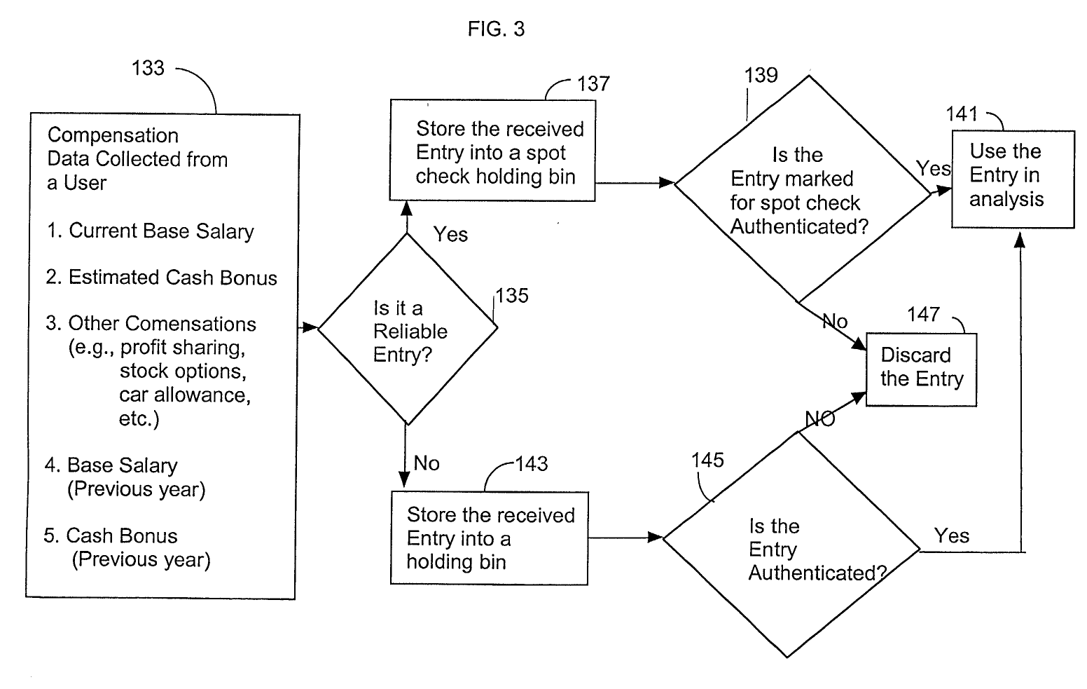

Referring to FIG. 3, various software applications when executed by processor 123 perform the following steps.

In step 133, compensation data entered by the members are received from a number of client computers 101—the compensation data are entered using one or more Web pages downloaded from server computer 131 as noted above in connection with FIG. 1. Compensation data received from each member may include data entries relating to base salary, estimated cash bonus and/or other incentive compensations such as profit sharing, stock options, car allowance, and other similar non-salary forms of compensation.

Upon receiving the compensation data from the members, each entry is separately evaluated for its reliability, at step 135. For instance, when an entry of current base salary is received from one of client computers 101, the entry value is compared with existing statistical data (e.g., an existing average and standard deviation of current base salary entered by other users employed by the same employer). If the entry value is within one standard deviation of the existing average, then the entry value is deemed to be reliable. On the other hand, if the entry value is more or less than one standard deviation, the entry value is deemed to be unreliable. It should be noted that two or three standard deviations or other statistical discrimination methods known in the art may also be utilized in determining the reliability of entry values.

In step 137, the entries deemed to be reliable data are stored into a holding bin (e.g., a memory location in RAM, hard disk, or a database management system). Only a certain percentage, preferably 11-20% (other exemplary ranges include 1-3% or 5-10%), of the entries are marked to be evaluated for their veracity in a later processing step. In other words, they are spot-checked for veracity.

In step 139, entry values that were deemed to be reliable but marked to be evaluated for veracity are authenticated. A preferred method of authenticating an entry value is to query the member who made the entries. Another method of authentication is to request one or more verifiable documents from the member who made the entries. Examples of verifiable documents include copies of W-2 forms, tax returns, pay stubs, or other similar documents. The entry values are compared with values in the verifiable documents for veracity. If the two values are substantially identical to each other then the entry value is deemed to be authenticated.

In step 141, the entry values that are not marked to be evaluated and the authenticated entry values are used in analyzing the compensation data. More specifically, the database contains compensation data that have been checked for reliability and evaluated for veracity. These compensation data are stored by the type of information (e.g., base salary, estimated cash bonus, and/or other incentive compensations such as profit sharing, stock options, car allowance, and other similar non-salary forms of compensation as discussed above), the location of employers (e.g., countries, geographical regions, states, and/or cities), specific industries (e.g., consulting, accounting, engineering) functional specification (e.g., marketing, finance, operations) and job categories (e.g., entry level, mid-level management, executive).

For each category, in addition to the actual entry values, a running average, standard deviation, and other statistical information are stored in database 131. As the latest entries are stored in database 131, the running average is continually updated. Further, the running average may use only recent entries (e.g, last one or two months if there is a drastic change in a specific job market) in calculating the average.

In step 143, the data entries deemed to be unreliable data are stored into the holding bin. Rather than being subjected to spot-checking, each unreliable entry value is flagged and then evaluated for veracity.

In step 145, each entry deemed to be unreliable is authenticated, as discussed above in step 139.

In step 141, entry values deemed to be unreliable but authenticated are stored in database 131 and are used in updating the statistical data stored in database 131.

In step 147, entry values deemed to be unreliable are discarded unless they are authenticated; entry values which fail the authentication step are also discarded.

When database 131 is sufficiently populated, upon receiving a request from client computer 101 to provide compensation data, the data stored in database 131 are retrieved and arranged in graphical format to be sent to client computer 101 as a part of a Web page. For instance, if a request to view a salary range for an entry-level consultant is received from client computers, all the relevant data relating to entry-level consultant positions are retrieved from database 131. The retrieved data are then processed to generate a number of graphs to be printed or displayed on a monitor.

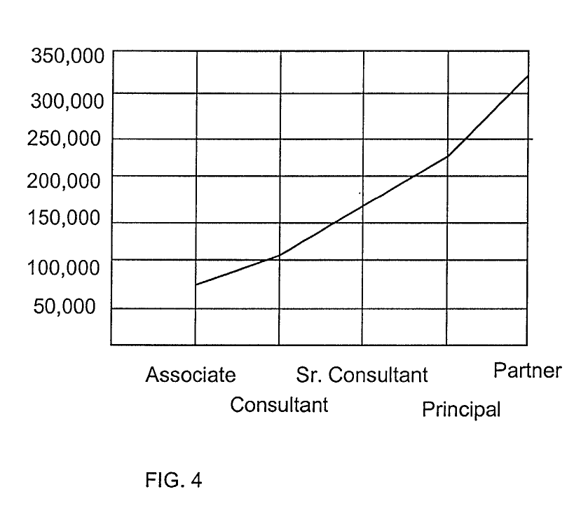

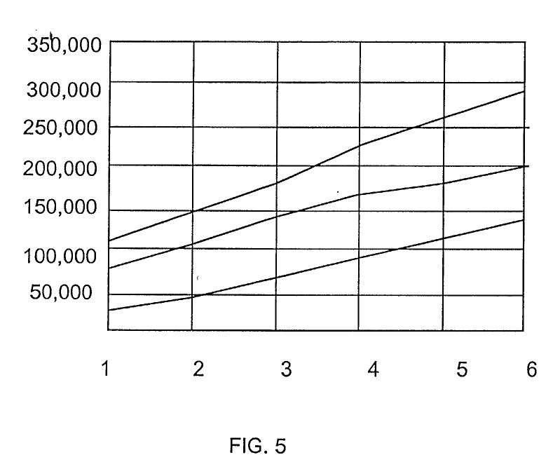

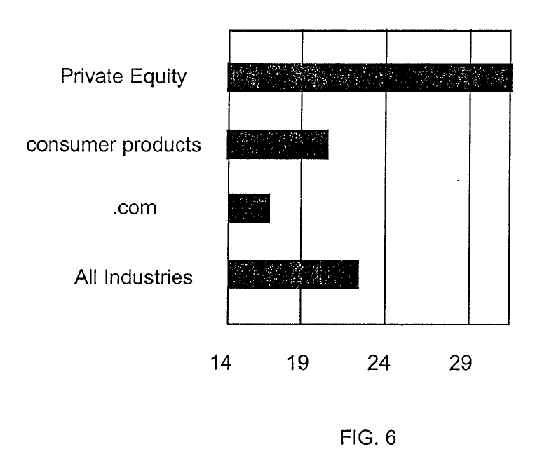

FIGS. 4-6 show exemplary graphs. In FIG. 4, a graph is provided to show annual salary versus various positions. In FIG. 5, a graph is provided to show annual salary of three individuals working for one firm versus number of years in service. In FIG. 6, a graph is provided to show increases in salaries when workers change jobs in various industries. In another example, a graph may include a first axis (i.e., x-axis) configured to display various cities where the company is located and a second axis (i.e., y-axis) configured to display salary ranges of each city. The salary range is preferably the average salary for each city. Alternatively, the salary range is the hi-lows of each city (e.g., one standard deviation from the average).

In another example, a user may request to compare potential earnings by staying with the current employer versus moving to another company. This type of information is preferably generated by retrieving information relating to other users who stayed with the current employer or moved to new employers.

Although the preferred embodiments of the invention have been described in the foregoing description, it will be understood that the present invention is not limited to the specific embodiments described above.

What is claimed is:

1. A method of providing compensation comparison data comprising:
receiving compensation data from a plurality of sources;
determining whether the received data is reliable;
marking each piece of received data as reliable or unreliable;
authenticating each piece of received data marked as unreliable; and
calculating an average of the authenticated data.

2. The method of claim 1 wherein the step of receiving compensation data comprises receiving data relating to at least one of current base salary and estimated cash bonus.

3. The method of claim 1 wherein the step of determining reliability of the received data comprises determining whether the received data falls within one standard deviation from the average.

4. The method of claim 1 further comprising spot-checking the reliable data for authenticity.

5. The method of claim 1 wherein the step of authenticating comprises querying persons who provided the compensation data or receiving one or more authenticating documents.

6. The method of claim 5 wherein the authenticating documents include a pay stub.

7. The method of claim 1 wherein the data are received only from individual users.

8. A computer system for providing compensation comparison data, wherein the system includes a server computer configured to:
receive compensation data from a plurality of sources;
determine whether the received data is reliable;
mark each piece of received data as reliable or unreliable;
authenticate each piece of received data marked as unreliable; and
calculate an average of the authenticated data.

9. The system of claim 8 wherein the server computer is further configured to receive data relating to at least one of current base salary and estimated cash bonus.

10. The system of claim 8 wherein the server computer is further configured to determine whether the received data falls within one standard deviation from the average.

11. The system of claim 8 wherein the server computer is further configured to spot-check the reliable data for authenticity.

12. The system of claim 8 wherein the server computer is further configured to receive one or more authenticating documents.

13. The system of claim 12 wherein the authenticating documents include a pay stub.

14. The system of claim 8 wherein the server computer is further configured to receive the data only from individual users.
